(19) United States
(12) Patent Application Publication
(10) Pub. No.: US 2013/0238467 A1
(43) Pub. Date: Sep. 12, 2013

(54) OBJECT DISPLAY SERVER, OBJECT DISPLAY METHOD, OBJECT DISPLAY PROGRAM, AND COMPUTER-READABLE RECORDING MEDIUM FOR STORING THE PROGRAM

(71) Applicants: Shigaku Iwabuchi, Shinagawa-ku (JP); Soh Masuko, Shinagawa-ku (JP); Hiroyuki Kamo, Tsukuba-shi (JP); Jiro Tanaka, Tsukuba-shi (JP)

(72) Inventors: Shigaku Iwabuchi, Shinagawa-ku (JP); Soh Masuko, Shinagawa-ku (JP); Hiroyuki Kamo, Tsukuba-shi (JP); Jiro Tanaka, Tsukuba-shi (JP)

(73) Assignee: RAKUTEN, INC., Shinagawa-ku, Tokyo (JP)

(21) Appl. No.: 13/882,772

(22) PCT Filed: Jun. 13, 2011
(86) PCT No.: PCT/JP2011/063535

§ 371 Date: May 1, 2013

(30) Foreign Application Priority Data
Jan. 13, 2011 (JP) 2011-004833

(51) Int. Cl. G06Q 30/06

(52) U.S. Cl. CPC G06Q 30/0625
USPC 705/26.62

(57) ABSTRACT

An AR server 30 includes a reception unit 31, which receives an image of a product-related item from a portable terminal 10 requesting a display object; a product specification unit 32, which specifies a product corresponding to a product-related item based on a result of image identification processing of the image and on product data in a product database 21; a writer specification unit 35, which refers to a writer database 23 storing post data indicating comments of writers on products, and specifies one or more writers who have commented on a specified product; an object generation unit 36, which generates one or more display objects indicating one or more specified writers; and a transmission unit 37, which transmits the display objects to the portable terminal 10 in order to implement superimposed-display of the generated display objects on the screen of the portable terminal 10.

### TECHNICAL FIELD

One mode of this invention relates to an object display server, object display method, object display program, and a computer-readable recording medium for storing the program.

### BACKGROUND ART

In the prior art, methods for displaying the degree of interest and degree of popularity of a product are known. For example, Patent Literature 1 discloses an access amount representation device which indicates, using sound volume, tone, or other acoustic means, the amount of accessing of products disposed in a virtually formed three-dimensional information space. Methods are also known for indicating such access amounts visually on web pages of online shopping sites.

### CITATION LIST

### Patent Literature

Patent Literature 1: Japanese Patent Application Laid-open No. H10-124295

### SUMMARY OF INVENTION

### Technical Problem

When using the method disclosed in Patent Literature 1 above, the user can only learn access amounts within the limited range of the virtual three-dimensional information space. The ability to learn the degree of interest in products one has seen in actual society (for example, products exhibited in an actual storefront, products displayed on an arbitrary web page, or similar), would be convenient for a user.

Thus there is a demand for the ability to present to a user the degree of interest in a product which the user has seen.

### Solution to Problem

An object display server of one mode of this invention is An object display server, which implements superimposed-display of a display object on a screen of a terminal which displaying a processing target relating to a product, the server including: reception means for receiving an image of the processing target from the terminal requesting the display object; product specification means for specifying a product corresponding to the processing target, based on a result of image identification processing on the image received by the reception means and on product data stored in a product database; person specification means for referring to an action database which stores action data indicating a prescribed action on a product taken by a person, and for specifying one or more persons who have taken a prescribed action on a product specified by the product specification means; object generation means for generating one or more display objects indicating one or more persons specified by the person specification means; and transmission means for transmitting the one or more display objects to the terminal, in order to implement superimposed-display, on a screen of the terminal, of one or more display objects generated by the object generation means.

An object display method of one mode of this invention is an object display method executed by an object display server which implements superimposed-display of a display object on a screen of a terminal which displaying a processing target relating to a product, this method including: a reception step of receiving an image of the processing target from the terminal requesting the display object; a product specification step of specifying a product corresponding to the processing target, based on a result of image identification processing of the image received in the reception step and product data stored in a product database; a person specification step of referring to an action database which stores action data indicating a prescribed action on a product taken by a person, and specifying one or more persons who have taken a prescribed action on a product specified in the product specification step; an object generation step of generating one or more display objects indicating one or more persons specified in the person specification step; and a transmission step of transmitting one or more display objects to the terminal, in order to implement superimposed-display, on a screen of the terminal, of the one or more display objects generated in the object generation step.

An object display program of one mode of the invention is an object display program which causes a computer to function as an object display server which implements superimposed-display of a display object on a screen of a terminal which displaying a processing target relating to a product, the computer being caused to function as: reception means for receiving an image of the processing target from the terminal requesting the display object; product specification means for specifying a product corresponding to the processing target, based on a result of image identification processing of an image received by the reception means and product data stored in a product database; person specification means for referring to an action database which stores action data indicating a prescribed action on a product taken by a person, and for specifying one or more persons who have taken a prescribed action on a product specified by the product specification means; object generation means for generating one or more display objects indicating one or more persons specified by the person specification means; and transmission means for transmitting the one or more display objects to the terminal, in order to implement superimposed-display, on a screen of the terminal, of one or more display objects generated by the object generation means.

A computer-readable recording medium of one mode of this invention is a computer-readable recording medium, which stores an object display program which causes a computer to function as an object display server which implements superimposed-display of a display object on a screen of a terminal which displaying a processing target relating to a product, the object display program causing the computer to function as: reception means for receiving an image of the processing target from the terminal requesting the display object; product specification means for specifying a product corresponding to the processing target, based on a result of image identification processing of an image received by the reception means and product data stored in a product database; person specification means for referring to an action database which stores action data indicating a prescribed action on a product taken by a person, and for specifying one or more persons who have taken a prescribed action on a product specified by the product specification means; object generation means for generating one or more display objects indicating one or more persons specified by the person specification means; and transmission means for transmitting the one or more display objects to the terminal, in order to implements superimposed-display, on a screen of the terminal, of one or more display objects generated by the object generation means.

By means of such modes, a product is specified from an image of a processing target obtained by a terminal, and persons who have taken a prescribed action on the product are specified. A display object indicating the specified persons is generated and is displayed superimposed on the screen of the terminal. In this way, by superimposed-display of a display object on a subject (processing target), the degree of interest (an index indicating the number of persons who are interested in the product or whether there is interest) in the product being viewed by the user of the terminal can be presented to the user.

In the object display server of another mode, the person specification means may extract user relation data indicating the relations between terminal users and persons from a user relation database which stores user relation data indicating relations between users, and the object generation means may generate each display object such that the display mode is different between persons associated with the user of the terminal and persons not associated with the user, based on the user relation data extracted by the person specification means.

In this case, the display state of each display object changes based on the relation between the terminal user and specified persons. As a result, the terminal user, merely by looking at the display object, can discriminate between persons in a prescribed relationship with himself and other persons.

In the object display server of still another mode, the object generation means may generate the display object of persons such that information relating to persons in a relation with the terminal user is displayed on the screen of the terminal.

In this case, information relating to persons in a prescribed relationship with the terminal user is displayed, and so the user can view this information.

In the object display server of still another mode, action data may include post data indicating comments related to a product on which the user has posted, the person specification means may refer to post data in an action database and specify one or more persons who have commented on the product as writers, and the object generation means may generate one or more display objects indicating one or more writers.

In this case, writers who have commented on the product are specified, and display objects indicating the writers are generated and are displayed superimposed on the terminal screen. By this means, the number of persons who have commented on the product can be presented to the terminal user.

In the object display server of still another mode, action data may include purchase data indicating user product purchases, the person specification means may refer to an action database and extract purchase data indicating that a writer has purchased a product, and the object generation means may generate each display object such that the display mode is different between writers who have purchased the product and writers who have not purchased the product, based on purchase data extracted by the person specification means.

In this case, the display mode changes for each display object according to whether a writer has or has not purchased the product. Hence simply by viewing display objects, the terminal user can ascertain the number of persons, among persons who have commented, who have actually purchased the product.

In the object display server of still another mode, action data may include purchase data indicating user product purchases, the person specification means may refer to purchase data within the action database, one or more persons who have purchased the product may be specified as purchasers, and the object generation means may generate one or more display objects indicating one or more purchasers.

In this case, product purchasers are specified, and display objects indicating the purchasers are generated and displayed superimposed on the terminal screen. By this means, the number of persons who have purchased the product can be presented to the terminal user.

In the object display server of still another mode, action data may include post data indicating comments related to the product posted by users, the person specification means may refer to the action database and extract post data indicating that purchasers have commented on the product, and the object generation means may generate each display object such that the display mode is different between purchasers who have commented on the product and purchasers who have not commented on the product, based on the post data extracted by the person specification means.

In this case, the display mode changes for each display object depending on whether the purchaser has posted on the product. Hence merely by viewing display objects, the terminal user can ascertain which persons among purchasers have posted on the product.

In the object display server of still another mode, a viewer database which stores viewer data indicating users who are viewing a product on a terminal screen may be provided, the person specification means may extract viewer data indicating persons viewing the product on a terminal screen, and the object generation means may generate each display object such that the display mode is different between persons viewing the product and persons not viewing the product, based on viewer data extracted by the person specification means.

In this case, the display mode for each display object changes according to whether the specified person is viewing the same product at the same time as the terminal user, and so the terminal user can ascertain the number of persons who are simultaneously viewing the same product.

In the object display server of still another mode, interface setting means may be further provided which, when there exists a person who is viewing a product, sets in the terminal a user interface enabling transmission and reception of messages between the terminal user and the person.

In this case, the terminal user can exchange messages with a person simultaneously viewing the same product, while viewing a display object which is displayed superimposed.

In the object display server of still another mode, the person specification means may extract user attribute data relating to persons from a user attribute database which stores user attribute data indicating the attributes of users, and the object generation means may decide a display mode for a display object based on user attribute data extracted by the person specification means.

In this case, the display mode of each display object changes based on the user attributes of the specified person, and so the terminal viewer can ascertain tendencies of persons indicating an interest in the product merely by viewing display objects.

In the object display server of still another mode, a processing target may be any among the entirety of or a portion of an actual article of a product, an image of a product, a character string that can specify a product, or an encoded character string.

### Advantageous Effects of Invention

By means of one aspect of the invention, the degree of interest in a product being viewed by a user can be presented to the user.

### BRIEF DESCRIPTION OF DRAWINGS

FIG. 1 shows the overall configuration of an information provision system including an AR server of an embodiment;

FIG. 2 is a block diagram showing the functional configuration of the portable terminal shown in FIG. 1;

FIG. 3 shows an example of superimposed-display of an object on the portable terminal shown in FIG. 1;

FIG. 4 shows an example of the product database shown in FIG. 1;

FIGS. 5(a) and 5(b) show examples of the product database shown in FIG. 1;

FIGS. 6(a) and 6(b) show examples of the purchase database shown in FIG. 1;

FIGS. 7(a) and 7(b) show examples of the post database shown in FIG. 1;

FIG. 8 shows an example of the user database shown in FIG. 1;

FIG. 9 is a block diagram showing the functional configuration of the AR server of an embodiment;

FIG. 10 shows the hardware configuration of the AR server shown in FIG. 9;

FIG. 11 shows an example of the viewer database shown in FIG. 9;

FIGS. 12(a) and 12(b) show examples of object data;

FIG. 13 shows an example of the display on a chart screen on the portable terminal shown in FIG. 1;

FIG. 14 is a sequence diagram showing operation of the information provision system (AR server) shown in FIG. 1;

FIG. 15 is a flowchart showing details of the processing to generate object data shown in FIG. 14;

FIG. 16 shows the configuration of the object display program of an embodiment; and

FIG. 17 is a block diagram showing the functional configuration of an AR server of a modified example.

### DESCRIPTION OF EMBODIMENTS

Below, an embodiment of the invention is explained in detail, referring to the attached drawings. In this embodiment, an object display server of one mode of the invention is applied to an AR (Augmented Reality) server. Elements which are the same or equivalent in explanations of the drawings are assigned the same symbols, and redundant explanations are omitted.

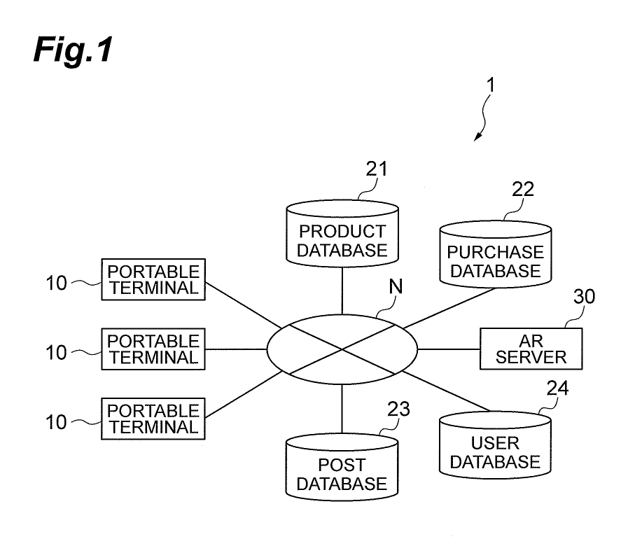

First, FIG. 1 to FIG. 13 are used to explain the functions and configuration of the information provision system 1 of the embodiment. The information provision system 1 is a computer system which provides a user, who is viewing a product on a screen of a portable terminal with a camera, with information indicating the degree of interest in the product (an index indicating the number of persons who are interested in the product or whether there has been interest). Specifically, the information provision system 1 represents the degree of interest using one or more person-figure display objects, and displays, superimposed on the screen of the portable terminal on which the product is shown, the one or more display objects.

As shown in FIG. 1, this information provision system 1 comprises portable terminals 10, product database 21, purchase database (action database) 22, post database (action database) 23, user database 24, and AR server 30. The terminals, databases, and server are capable of intercommunication via a communication network N, configured using the Internet or similar.

First, the portable terminals 10 are explained. A portable terminal 10 is a communication terminal owned by a user, and comprises a camera and a monitor provided with a viewfinder function. Examples of portable terminals 10 include highly functional portable telephones (“smartphones”) and portable information terminals (PDAs), but portable terminals 10 are not limited to these types of devices. In the example of FIG. 1, three portable terminals 10 are shown, but no limitations in particular are placed on the number of portable terminals 10 in the information provision system 1.

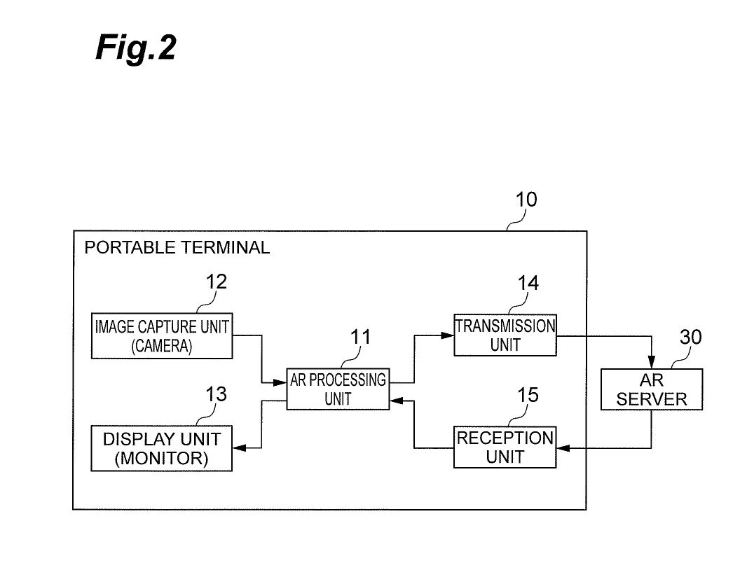

As shown in FIG. 2, a portable terminal 10 comprises, as functional constituent elements, an AR processing unit 11, image capture unit (camera) 12, display unit (monitor) 13, transmission unit 14, and reception unit 15. In this embodiment, the AR processing unit 11 controls the image capture unit 12, display unit 13, transmission unit 14 and reception unit 15.

The AR processing unit 11 is means for superimposed-display of person-figure display objects on an image being displayed on the display unit 13 when the image capture unit 12 is activated. The AR processing unit 11 is activated by a prescribed operation by the user, and executes the series of processing indicated below.

The AR processing unit 11 acquires an image (photographic data) captured by the image capture unit 12. In this image, a processing target relating to a product is replicated. Below, this processing target (subject) is called a “product-related item”. For example, the user can capture images, on the spot, of products exhibited in stores, products appearing on outdoor billboards, products displayed on arbitrary web pages, and similar. The product-related item an image of which is captured may be anything enabling specification of the product. For example, the entirety of or a portion of an actual product, a product image displayed on the monitor of a personal computer or on an electronic billboard, the POP (Point of Purchase), and a character string (product name, serial number, or similar) which can specify the product, are examples of product-related items. A character string which can specify a product may be encoded as a product barcode or using a marker or similar for AR processing. A plurality of product-related items may be replicated in a single image.

Further, the AR processing unit 11 reads out, from prescribed memory within the portable terminal 10, a user ID uniquely specifying the user of the portable terminal 10. This user ID is preset.

Next, the AR processing unit 11 outputs the acquired photographic data and the user ID to the transmission unit 14. The transmission unit 14 transmits these data items to the AR server 30.

When the photographic data and user ID are sent to the AR server 30, the AR server 30 executes the processing described below, and transmits image data of one or more display objects to the portable terminal 10. The reception unit 15 receives this image data and outputs the image data to the AR processing unit 11. The AR processing unit 11 displays, in superimposition on the display unit 13, one or more display objects, based on the image data acquired.

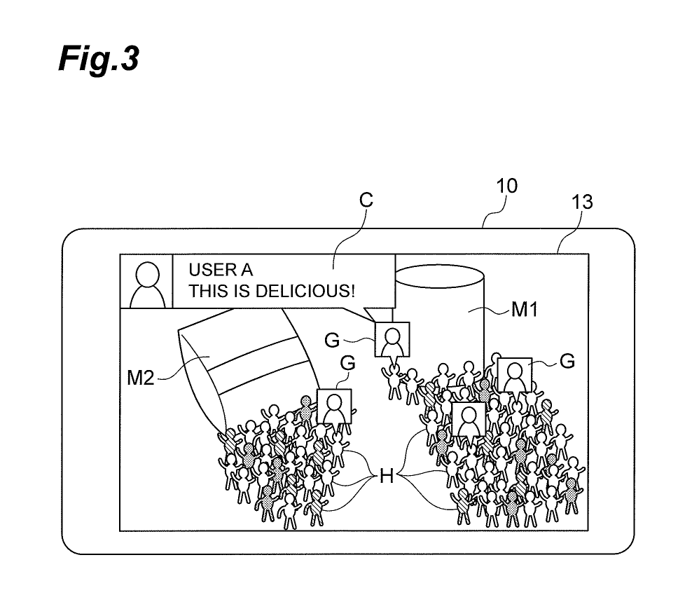

By this means, one or more display objects H are displayed on the image captured by the image capture unit 12, as shown in FIG. 3. Details are explained below, but one a display object H indicates one or a plurality of writers who have commented on the product. In the example of FIG. 3, a plurality of display objects H are displayed superimposed so as to be arranged at each of the products M1 and M2 replicated in the display unit 13. At this time, if the display is controlled such that, rather than displaying all of the display objects H all together, each of the display objects H appears to approach the product from an edge of the screen, a more powerful visual effect can be imparted to the user. By displaying display objects as shown in FIG. 3, the user can, at a glance, ascertain and compare the degrees of interest, degrees of popularity, and similar of products.

Images of writers (for example, head shots) G are displayed above the heads of a number of the display objects H; these indicate that the writers corresponding to the display objects H are in a friendly relationship with the user of the portable terminal 10.

When the user performs a tapping operation on a display object H or on an image G, a comment C of the writer corresponding to the display object H or the image G is displayed as a result of control by the AR processing unit 11. When a single a display object H indicates a plurality of writers, each time a tapping operation is performed on the display object, or else automatically, a photograph of each writer and a comment may be switched and displayed in order.

When a display object H is tapped, the AR processing unit 11 may cause display on the screen of a user interface for creation and transmission of a message to the user corresponding to the display object. Further, the AR processing unit 11 may rearrange the display objects H being displayed on the screen according to a prescribed user attribute (for example, gender or age, or similar) according to a prescribed operation by the user. Further, the AR processing unit 11 may refer to the purchase database 22 and product database 21, described below, and may cause a history of products purchased in the past by the writer corresponding to the display object to be displayed on the screen.

The method of superimposed-display is not limited to the example of FIG. 3. For example, rather than arranging display objects H with respect to a product, the display objects H may be displayed so as to surround the product. Further, in place of images G, comments by writers may be displayed in speech-balloon style.

In any case, by displaying in superimposition person-figure display objects H as shown in FIG. 3, the existence of writers who have commented on the product can be intuitively conveyed to the user. Hence the information provision system 1 can be a system which imparts a sense of augmented reality to the user of the portable terminal 10.

Next, the databases accessed by the AR server 30 are explained.

The product database 21 is means for storing product data relating to products. The product database 21 exists for example as one portion of an online shopping server.

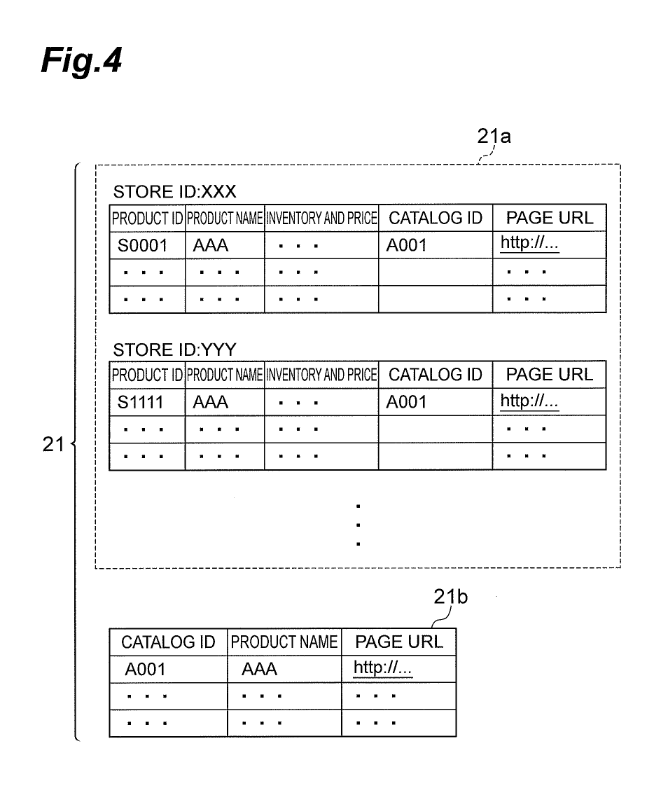

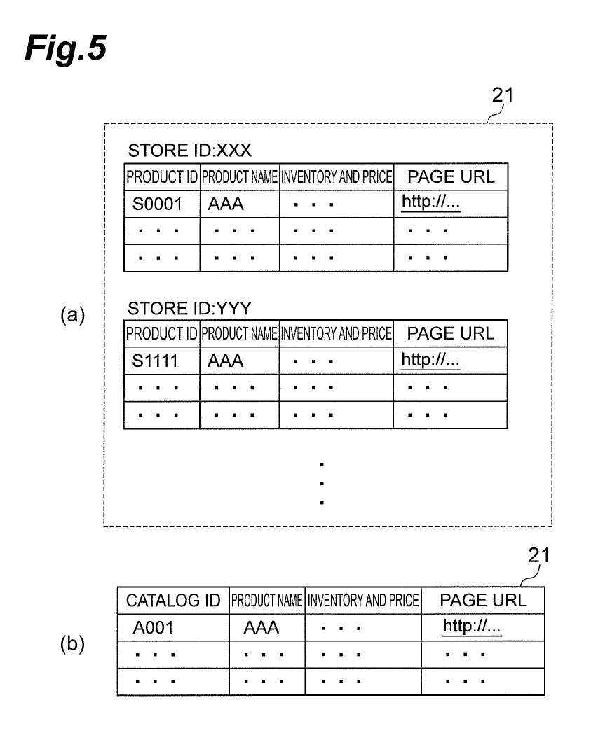

FIG. 4 and FIG. 5 show examples of the configuration of the product database 21. In the example of FIG. 4, the product database 21 includes a stocked product table 21a relating to products stocked at each store, and a catalog table 21b relating to the products themselves. The stocked product table 21a stores stocked product data, in which store IDs which uniquely specify stores, product IDs which uniquely specify products in stores, product names, inventory, prices, catalog IDs which uniquely specify the products themselves, and the URLs of web pages (page URLs) on which product images appear, are associated. On the other hand, the catalog table 21b stores catalog data, in which catalog IDs, product names, and page URLs are associated. Hence in the example of FIG. 4, product data consists of stocked product data and catalog data. A product ID is an ID allocated to a product by a store independently, and even for the same product, will be different for different stores. On the other hand, the catalog ID is an ID allocated to the product itself, and the catalog ID of a product will be the same for different stores.

In the example of FIG. 5(a), the product database 21 stores product data associating store IDs, product IDs, product names, inventory, prices, and page URLs. In this case, a product itself can be specified from the product name. In the example of FIG. 5(b), the product database 21 stores product data associating catalog IDs, product names, inventory, prices, and page URLs. The configuration shown in FIG. 5(b) can be used when product identifiers are common among stores, and when only product data relating to products of a single specific store is stored.

In the above example, product names, inventory, prices, and page URLs were given as attributes of products appearing in product data; but the types of product attributes stored in the product database 21 are not limited to these.

The purchase database 22 is means for storing purchase data relating to user product purchases. The purchase database 22 exists for example as a portion of an online shopping server. Purchase data is one type of action data indicating prescribed actions taken by persons on products, and is registered when a user performs a purchase operation at an online shopping site.

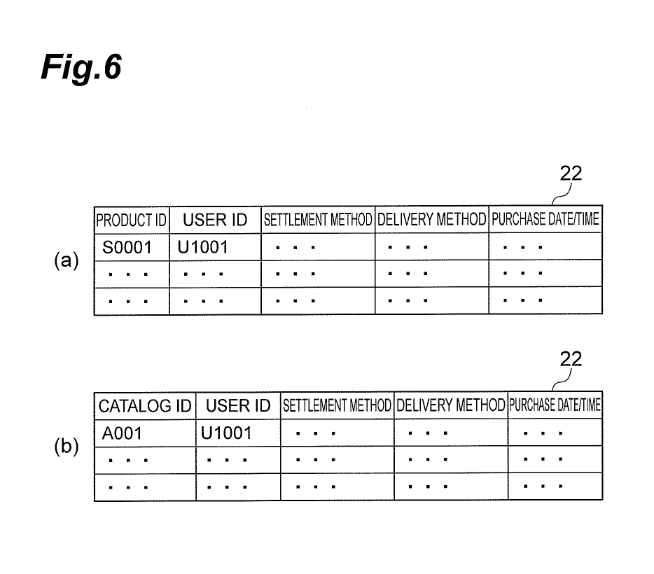

The configuration of purchase data differs according to the configuration of the product database 21. In the example of FIG. 6(a), the purchase database 22 stores purchase data associating product IDs, user IDs, settlement methods, delivery methods, and purchase date/times; this configuration corresponds to the configurations of the product database 21 in FIG. 4 and FIG. 5(a). In the example of FIG. 6(b), the purchase database 22 stores purchase data associating catalog IDs, user IDs, settlement methods, delivery methods, and purchase date/times; this configuration corresponds to the configuration of the product database 21 shown in FIG. 5(b). In all cases, purchase data is data which associates purchasers (user IDs) and purchased products (product IDs or catalog IDs). In this embodiment, settlement methods, delivery methods, and purchase date/times are shown as supplementary information relating to purchases, but the types of supplementary information are not limited to these, and may be freely determined.

The post database 23 is means for storing post data, indicating comments (so-called word-of-mouth) relating to products on which users have posted. The post database 23 exists for example as a portion of a microblog server or an online shopping server. Post data is one type of action data indicating a prescribed action on products taken by persons, and is registered when a user performs a posting operation at a prescribed web site. A terminal used to input comments may be a portable terminal 10, or may be a personal computer or other type of terminal.

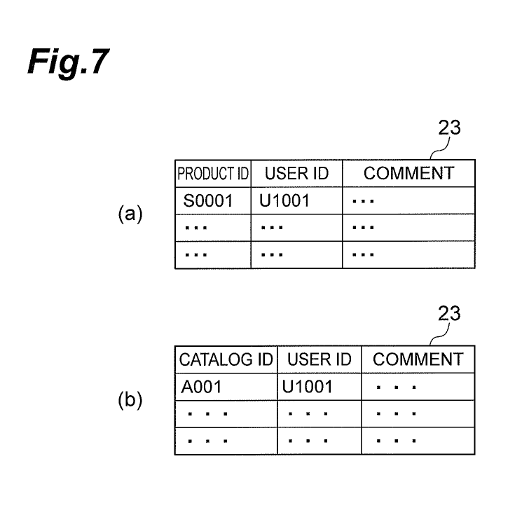

The configuration of post data differs according to the configuration of the product database 21. In the example of FIG. 7(a), the post database 23 stores post data, associating product IDs, user IDs, and comments (product impressions, recommendations and similar, posted by users); this configuration corresponds to the configurations of the product database 21 shown in FIG. 4 and FIG. 5(a). In the example of FIG. 7(b), the post database 23 stores post data associating catalog IDs, user IDs, and comments; this configuration corresponds to the configuration of the product database 21 shown in FIG. 5(b). Each product can also be specified from the URL of the product web page on which a comment has been posted. Hence in place of a product ID or a catalog ID a page URL in the product database 21 may be used to generate post data.

The user database 24 is means for storing user data relating to users. The user database 24 exists for example as a portion of a microblog server or an online shopping server. User data is registered when member registration is performed on a microblog service, online shopping service, social networking service (SNS), or other prescribed service.

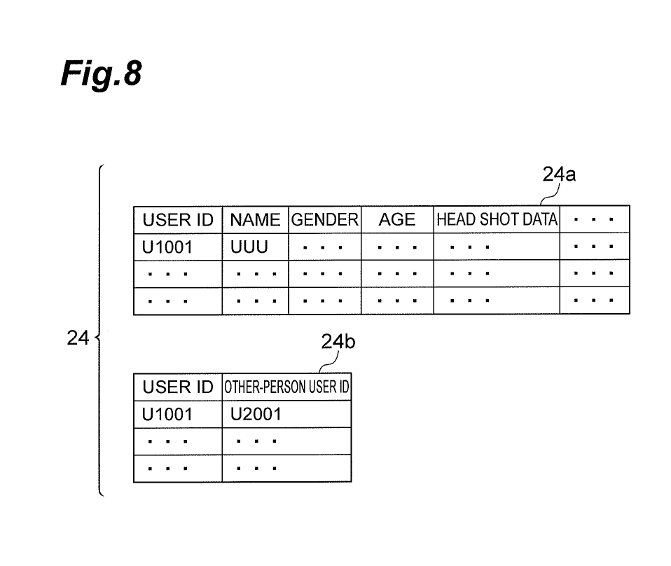

As shown in FIG. 8, the user database 24 includes a user attribute table (user attribute database) 24a which stores attributes for each user, and a user relation table (user relation database) 24b which stores friendship relations (relations between users) within the information provision system 1. The user attribute table 24a stores user attribute data associating user IDs, names, genders, ages, head shots, and other attribute information. On the other hand, the user relation table 24b stores user relation data associating the user IDs of two users in a friendship relation. Hence user data includes user attribute data and user relation data.

In the above example, names, genders, ages, and head shots were specifically indicated as user attributes described by user attribute data; but the types of user attributes stored in the user database 24 are not limited to these. Further, in this embodiment “friendship relation” is indicated as an example of a relation between users, but how relations between users are specifically set can be freely determined.

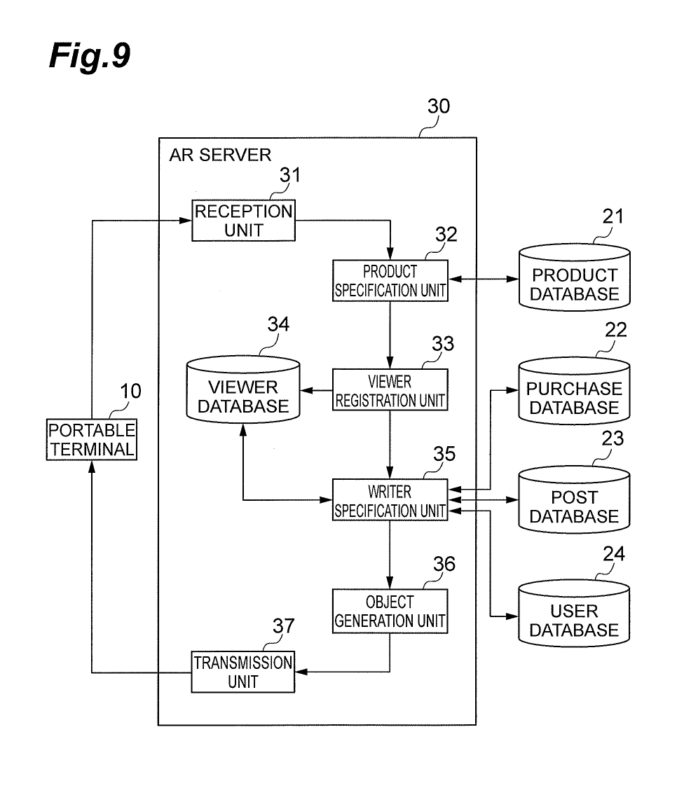

Next, the AR server 30 is explained. The AR server 30 is a computer which transmits display objects, indicating the degree of interest in products, to a portable terminal 10 based on a request from the portable terminal 10. As shown in FIG. 9, the AR server 30 comprises as functional constituent elements a reception unit (reception means) 31, product specification unit (product specification means) 32, viewer registration unit 33, viewer database 34, writer specification unit (person specification means) 35, object generation unit (object generation means, interface setting means) 36, and transmission unit (transmission means) 37.

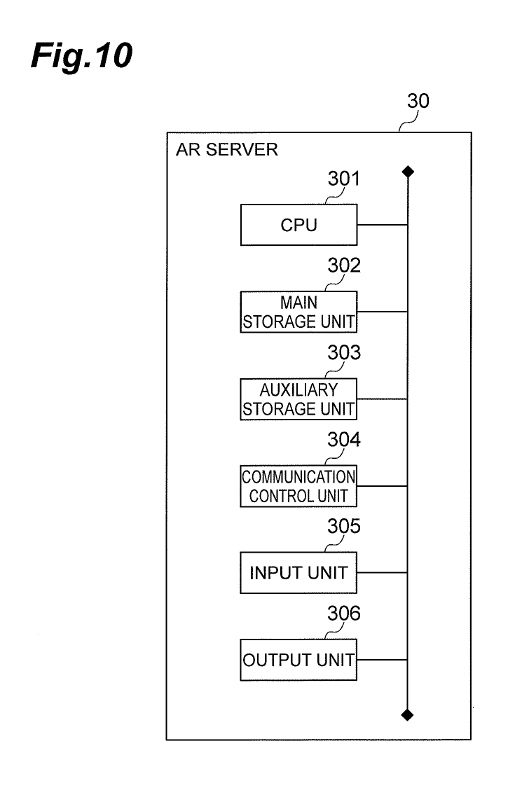

As shown in FIG. 10, the AR server 30 is configured using a CPU 301 which executes an operating system, application programs, and similar; a main storage portion 302, including ROM and RAM; an auxiliary storage portion 303, including a hard disk drive and similar; a communication control portion 304 including a network card and similar; an input portion 305, including a keyboard, mouse, and similar; and a monitor or other output portion 306. Each of the functions of the AR server 30 is realized by causing the CPU 301 and main storage portion 302 to read in prescribed software, causing the communication control portion 304, input portion 305, output portion 306 and similar to operate under control of the CPU 301, and performing data reading and writing in the main storage portion 302 and auxiliary storage portion 303. Data and databases necessary for processing are stored in the main storage portion 302 and auxiliary storage portion 303.

In FIG. 10, the AR server 30 is shown as configured using a single computer, but the functions of the AR server 30 may be distributed among a plurality of computers. For example, the AR server 30 may be configured using a computer comprising the viewer database 34 and a computer comprising the other functional constituent elements.

Returning to FIG. 9, the reception unit 31 is means for receiving user IDs and photographic data from the portable terminal 10, and outputting these to the product specification unit 32.

The product specification unit 32 is means for specifying a product corresponding to a product-related item indicated by photographic data, based on the result of image identification processing of the photographic data and on product data stored in the product database 21.

If a marker, bar code, product name, or other product-related item which can uniquely specify a product is replicated, then by executing image identification processing of the photographic data, the product specification unit 32 acquires the product name, catalog ID, or other character string data. Then, the product specification unit 32 reads product data corresponding to the acquired character string data from the product database 21, and finally confirms a catalog ID or product name which uniquely specifies the product itself.

On the other hand, when only the shape, color and similar of a product are captured, by executing image recognition processing of photographic data, the product specification unit 32 extracts an image of a product-related item. Next, by comparing the extracted image with product images indicated in the product data within the product database 21 (for example, product images carried on web pages indicated by page URLs), the product specification unit 32 infers the product replicated by the portable terminal 10. Then, the product specification unit 32 reads out from the product database 21a catalog ID or product name which uniquely specifies the inferred product itself. At the time of specification processing based on such image comparison, the product specification unit 32 can use techniques of the prior art, such as those described in References 1 and 2 below.
Reference 1: Masaki Masuda, “The Amazon's official application with ‘Photo Search’ is popular” (online), Jun. 7, 2010 (retrieved Aug. 24, 2010), URL: http://techwave.jp/archives/51461554.html
Reference 2: “Amazon provides applications for iPhone, including ‘Photo Search’ using camera, at no charge” (online), Jun. 18, 2010 (retrieved Aug. 24, 2010), URL: http://web-tan.forum.impressrd.jp/e/2010/06/18/8185

When the portable terminal 10 has replicated a plurality of product-related items, the product specification unit 32 acquires catalog IDs or product names for each of the product-related items. The product specification unit 32 outputs the one or more catalog IDs or product names acquired in this way, together with the input user ID, to the viewer registration unit 33. Hereafter, catalog IDs or product names which are finally obtained by the product specification unit are together called “product identifiers”.

The viewer registration unit 33 is means for registering, in the viewer database 34, a user viewing a product-related item on the screen of his portable terminal 10, that is, a user viewing a product-related item via the portable terminal 10. Specifically, the viewer registration unit 33 generates viewer data by associating one or more product identifiers with a user ID, and registers the data in the viewer database 34. At this time, if viewer data for the same user ID is already stored in the viewer database 34, the viewer registration unit 33 replaces the viewer data for the user ID with the newly generated data. When processing by the AR processing unit 11 in the portable terminal 10 has ended, the viewer registration unit 33 deletes viewer data relating to the user of the portable terminal 10 from the viewer database 34 based on a delete instruction received from the AR processing unit 11.

When this updating of viewer data is completed, the viewer registration unit 33 outputs the input user ID and product identifiers to the writer specification unit 35.

The viewer database 34 is means for storing viewer data indicating users who are replicating product-related items. As explained above, viewer data for each user is updated promptly according to the working state and image capture state of the AR processing unit 11. That is, viewer data reflects, in realtime, the state of image capture of product-related items by each portable terminal 10.

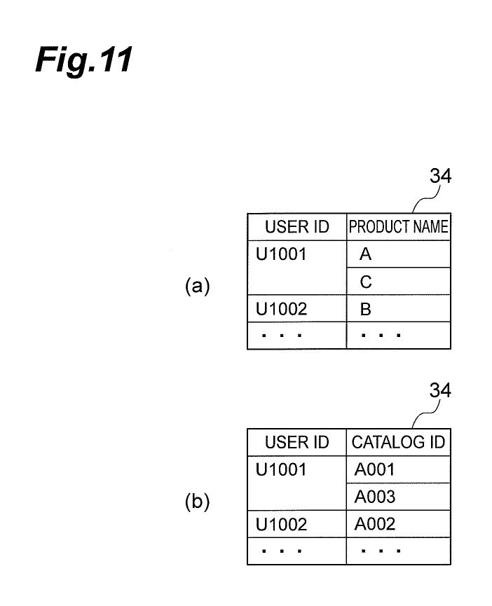

The configuration of viewer data differs according to how the product itself is specified. In the example of FIG. 11(a), the viewer database 34 stores viewer data which associates one user ID with one or more product names. On the other hand, in the example of FIG. 11(b), the viewer database 34 stores viewer data which associates one user ID with one or more catalog IDs.

The writer specification unit 35 is means for referring to the post database 23 and specifying one or more writers who have commented on a product specified by the product specification unit 32. The writer specification unit 35 performs the following processing for each input product identifier.

First, the writer specification unit 35 reads out post data corresponding to a product identifier from the post database 23, to extract writers who have commented on the specified product. At this time, when the post data includes a product ID, as in FIG. 7(a), the writer specification unit 35 reads out one or more product IDs corresponding to a product identifier from the product database 21, and reads out post data corresponding to the one or more product IDs from the post database 23. When there exists a user who has posted a plurality of times on one product, the post data for the user is extracted a plurality of times, but in this case the writer specification unit 35 combines the redundant user IDs into one.

Next, the writer specification unit 35 acquires attributes for each writer, and acquires the relations between the user requesting display objects (requesting user) and the writers. Specifically, the writer specification unit 35 reads out, from the user database 24, user attribute data corresponding to an input user ID (ID of the requesting user; hereafter called the “requesting user ID”), and one or more user attribute data corresponding to each extracted user ID (user IDs of posting users; hereafter called “writer IDs”). Further, for each writer ID, the writer specification unit 35 reads out, from the user database 24, user relation data associating the requesting user ID and the writer ID. User relation data is registered by setting a friendship relation between users, and thus user relation data may not be read out for all writer IDs, and there may be cases in which the writer specification unit 35 does not read out even one user relation data item.

Next, the writer specification unit 35 acquires the product purchase state for each writer. Specifically, for each writer ID, the writer specification unit 35 reads out from the purchase database 22 purchase data corresponding to the product identifier and the writer ID. At this time, if the purchase data includes a product ID as in FIG. 6(a), the writer specification unit 35 reads out from the product database 21 one or more product IDs corresponding to the product identifier, and reads out from the purchase database 22 purchase data corresponding to the one or more product IDs. Purchase data is registered as a consequence of a purchase of a product by a user, and so purchase data may not be read out for all writer IDs, and there may be cases in which the writer specification unit 35 does not read out even one purchase data item.

Next, the writer specification unit 35 specifies a user, among the writers, who at the current time is viewing the same product as the requesting user via a portable terminal 10. Specifically, for each writer ID, the writer specification unit 35 reads out from the viewer database 34 viewer data corresponding to the product identifier and the writer ID. Viewer data is registered as a result of a user viewing a product-related item via a portable terminal 10, and so viewer data may not be read out for all writer IDs, and there may be causes in which the writer specification unit 35 does not read out even one viewer data item.

Next, the writer specification unit 35 generates object data corresponding to display objects based on the acquired data. Object data is data associating a product identifier, writer ID, user attribute, friendship flag, purchased flag, and viewing flag.

User attributes are each of the user attributes indicated by user relation data. The friendship flag is set to “1” if the requesting user and the writer are registered as friends, and to “0” if not registered as friends. The purchased flag is set to “1” if the writer has purchased the product, and to “0” otherwise. The viewing flag is set to “1” if the writer is currently viewing the product via a portable terminal 10, and to “0” otherwise.

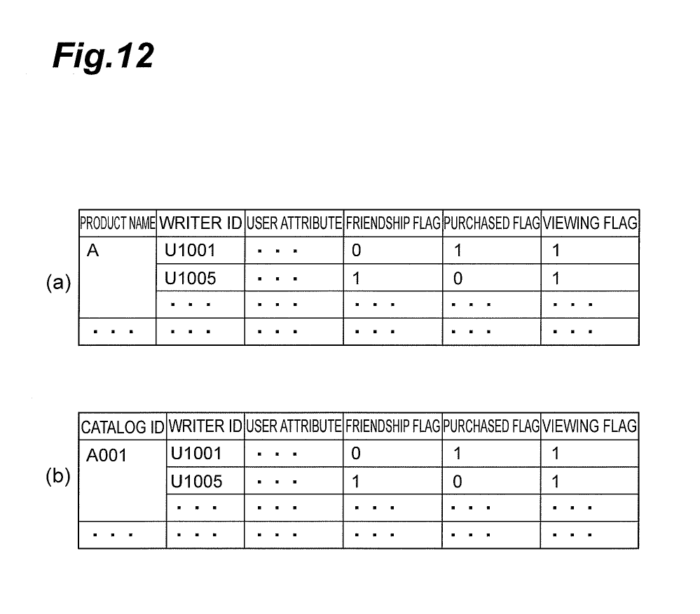

An example of object data is shown in FIG. 12. FIG. 12(a) is for a case in which the product identifier is a product name, and FIG. 12(b) is for a case in which the product identifier is a catalog ID. From FIG. 12, it is seen that for example the writer indicated by the user ID “U1005” is in a friendship relation with the requesting user. Further, it is seen that the writer has not purchased the product which is “product A”, but is currently showing this product on a portable terminal 10.

The writer specification unit 35 generates object data, as described above, for each product identifier input. The writer specification unit 35 then outputs the object data to the object generation unit 36.

The object generation unit 36 is means for generating one or more display objects indicating one or more writers specified by the writer specification unit 35. The object generation unit 36 may generate each display object such that one a display object indicates one writer, or may generate each display object such that one a display object indicates a plurality of (for example, ten, or one hundred, or similar) writers. That is, the relation between display objects and writers need not be a 1:1 relationship.

The object generation unit 36 generates image data for display objects based on the input object data. At this time, the object generation unit 36 decides a display mode for each display object based on the object data. When a plurality of writers are indicated by a single a display object, prior to deciding the display mode, the object generation unit 36 groups the input object data into groups having the same user attributes and the same flag values. Below, each such group of grouped writers is called a “writer group”. How to establish the display mode may be freely determined; a number of examples are described below.

The object generation unit 36 may change the color and size of a display object based on the age, gender, or other user attributes. Further, the object generation unit 36 may compare the user attributes of a writer (or of a writer group) with the user attributes of the requesting user, and may cause the display mode of a display object of a writer (or a writer group) which has attributes in common with the requesting user to be different from the display mode of a display object of a writer (or writer group) not having attributes in common.

The object generation unit 36 may display, above the head of only a display object for which the friendship flag is “1”, an image of the writer (or writer group) (for example, a head shot; see the images G in FIG. 3), or a comment by the writer (or writer group) on the specified product. Further, the object generation unit 36 may change the color or size of a display object based on the friendship flag. As explained above, the method of representation of images and comments when a display object indicates a writer may be freely determined.

The object generation unit 36 may set the display position of each display object such that a display object for which the purchased flag is “1” is displayed more closely to the target than a display object the same flag of which is “0”. Further, the object generation unit 36 may change the color and size of a display object based on the purchased flag.

The object generation unit 36 may display an image of a writer (or writer group) only above the head of display objects the viewing flag of which is “1”. Further, the object generation unit 36 may change the color and size of a display object based on the viewing flag.

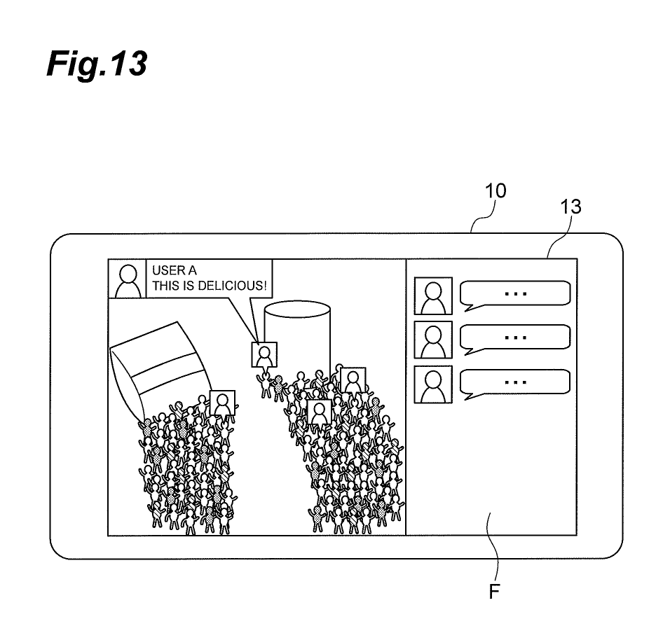

In addition to generation of such display objects, when object data for which the viewing flag is “1” exists, the object generation unit 36 generates instruction data to cause a user interface for message transmission/reception to be displayed on the portable terminal 10. This user interface is a tool for the user of the portable terminal 10 to transmit and receive messages with one or a plurality of users viewing the same product using other portable terminals 10. For example, the object generation unit 36 generates instruction data to cause display, on the display unit 13 of the portable terminal 10, of a screen for chat F as shown in FIG. 13. However, the specific configuration of the user interface may be freely determined.

The object generation unit 36 outputs image data of display objects to the transmission unit 37, and depending on the circumstances, outputs generated instruction data to the transmission unit 37.

The object generation unit 36 may have, determined in advance, upper limits to the number of display objects to be displayed for each product and to the total number of display objects to be displayed on one screen, and when the number of display objects exceeds the upper limit, generation of display objects may be discontinued. In this case, the display objects displayed on the portable terminal 10 do not completely reflect the number of writers, but the user can be provided with the approximately degree of interest for each product without excessively burdening the portable terminal 10 which performs image processing.

The transmission unit 37 is means for transmitting image data of display objects from the object generation unit 36 to the portable terminal 10. By this means, display objects corresponding to each product are displayed superimposed on the display unit 13 of the portable terminal 10, as shown in FIG. 3. Further, in some circumstances the transmission unit 37 may also transmit instruction data to the portable terminal 10. In this case, a user interface such as a screen for chat F is displayed on the display unit 13 of the portable terminal 10.

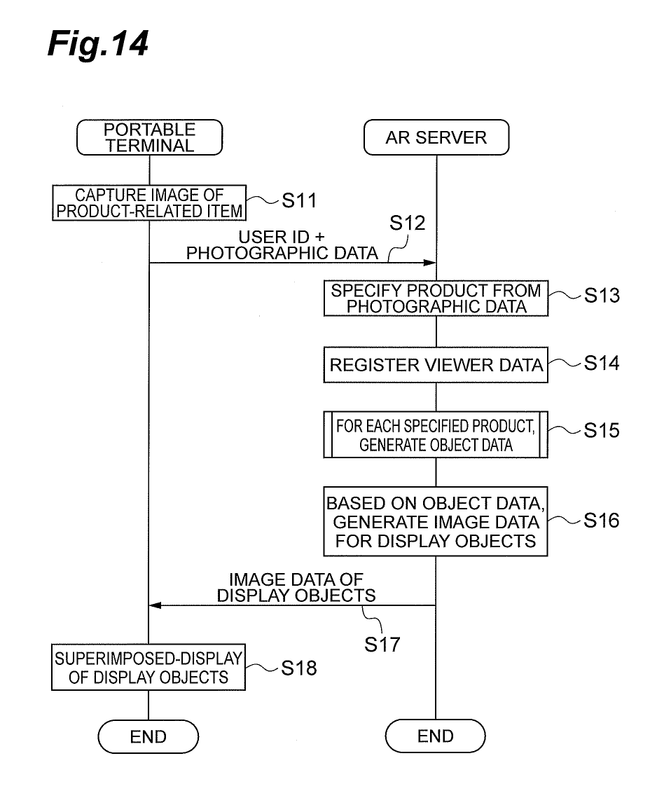

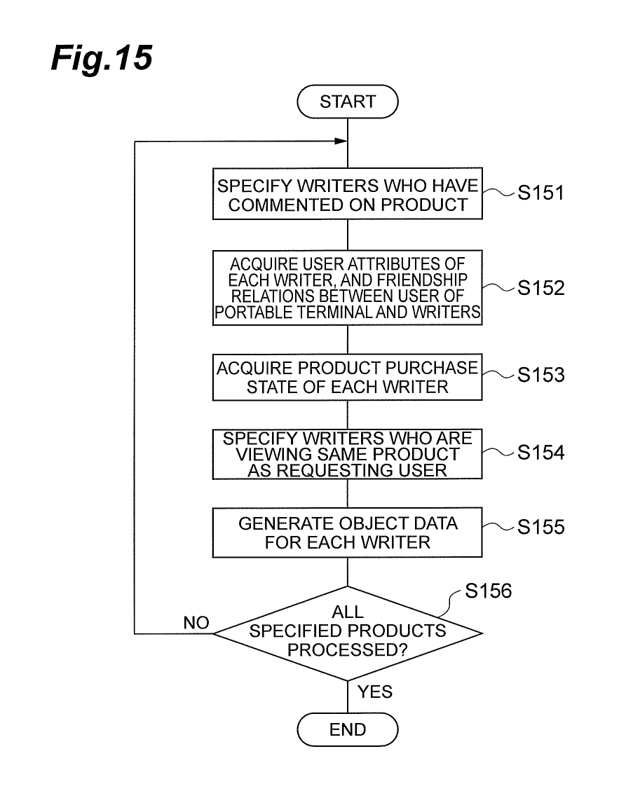

Next, operation of the information provision system 1 shown in FIG. 1 (and in particular the AR server 30), as well as a method of object display of this embodiment, are explained using FIG. 14 and FIG. 15.

First, in a portable terminal 10, an image of a product-related item is captured under control of the AR processing unit 11 (step S11), and the photographic data is sent together with the ID of the user of the portable terminal 10 to the AR server (step S12).

In the AR server 30, the reception unit 31 receives the photographic data and user ID (reception step), and the product specification unit 32 specifies the product replicated in the image of the photographic data (step S13, product specification step). Specifically, the product specification unit 32 performs prescribed image recognition processing of the photographic data, and searches the product database 21 to extract a product identifier (product name or catalog ID) corresponding to the product-related item.

Next, the viewer registration unit 33 generates viewer data by associating the received user ID and the extracted product identifier, and registers this data in the viewer database 34 (step S14). Then, the writer specification unit 35 generates object data for each product specified (step S15).

Object data generation is performed as shown in FIG. 15. That is, the writer specification unit 35 reads out writer data corresponding to product identifiers from the writer database 23, to specify writers commenting on a specified product (step S151, person specification step). Next, the writer specification unit 35 acquires user attributes for each writer and the friendship relation between the user of the portable terminal 10 and each writer from the user database 24 (step S152). Further, the writer specification unit 35 refers to the purchase database 22 and acquires the product purchase state for each writer (step S153). Further, the writer specification unit 35 refers to the viewer database 34 and specifies writers who are viewing the same product as the requesting user (step S154). The writer specification unit 35 then generates object data for each writer based on these search results (step S155). The writer specification unit 35 performs the processing of the above steps S151 to S155 for all specified products (step S156).

Returning to FIG. 14, when all object data has been obtained, the object generation unit 36 generates image data for display objects based on each object data item (step S16, object generation step). At this time, the object generation unit 36 uses a method like that described above to set the display mode for each display object. Finally, the transmission unit 37 transmits the generated image data to the portable terminal 10 (step S17, transmission step).

In the portable terminal 10, the image data for the display objects is displayed superimposed on the display unit 13 under the control of the AR processing unit 11 (step S18). By this means, the user of the portable terminal 10 can view a screen such as that shown in FIG. 3, and at a glance can ascertain how many other persons are interested in, or have been interested in, the product the image of which is being captured.

In the processing of the above steps S16 to S18, processing to set a user interface such as a screen for chat F may be performed in parallel.

The series of processing shown in FIG. 14 and FIG. 15 is executed repeatedly each time a product-related item shown on the portable terminal 10 changes. Hence the display of display objects (person-figure objects) such as that of FIG. 3 is updated in realtime.

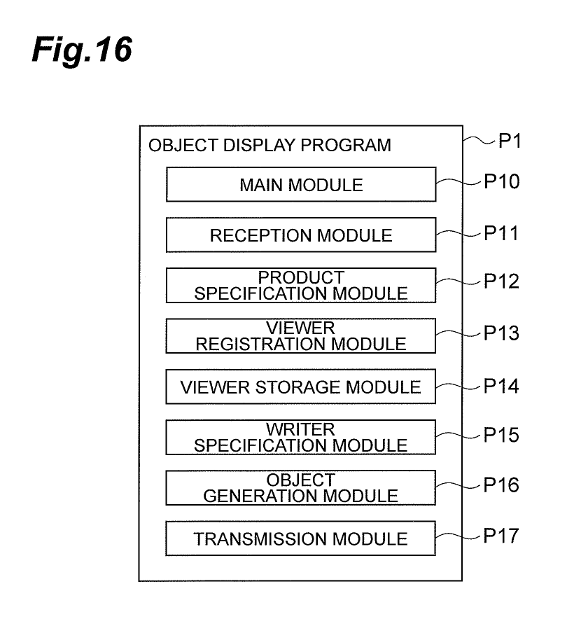

Next, FIG. 16 is used to explain a search program (object display program) P1 to cause a computer to function as an AR server 30.

The object display program P1 comprises a main module P10, reception module P11, product specification module P12, viewer registration module P13, viewer storage module P14, writer specification module P15, object generation module P16, and transmission module P17.

The main module P10 is a portion which comprehensively controls object display functions. The functions realized by executing the reception module P11, product specification module P12, viewer registration module P13, viewer storage module P14, writer specification module P15, object generation module P16, and transmission module P17 are similar to the respective functions of the above-described reception unit 31, product specification unit 32, viewer registration unit 33, viewer database 34, writer specification unit 35, object generation unit 36, and transmission unit 37.

The object display program P1 is recorded in a fixed manner and provided on a tangible recording medium such as for example a CD-ROM, DVD-ROM, semiconductor memory, or similar. The object display program P1 may also be provided via a communication network as data signals superimposed on a carrier wave.

As explained above, in this embodiment products are specified from images of product-related items obtained by a portable terminal 10, and writers who have commented on these products are specified. Then, display objects indicating writers are generated, and are displayed superimposed on the screen of the portable terminal 10. By thus displaying, superimposed on the screen of the portable terminal 10, display objects indicating writers, the user of the portable terminal 10 can be presented with degrees of interest (excitement) of products. For example, if the user views a product exhibited in an actual store on his portable terminal 10, he can learn to what extent others are interested in the product. Hence the user can, on the spot, learn the degree of interest and degree of popularity of the product, without going to the trouble of accessing a specific web site presenting the degree of interest in the product. For example, the user can promptly and on the spot learn the degree of interest in a product exhibited in an actual store, a product appearing on an outdoor billboard, or a product displayed on a web page not having functions for presenting the degree of interest.

By imparting such augmented reality to the user, it is expected that the desire of the user to purchase the product can be heightened. For example, a user can be enticed to purchase a product on which numerous display objects are displayed superimposed (a product with a high degree of popularity), or can be enticed to purchase a product for which few display objects are displayed (a product which not many other persons own).

Further, by using person-figures as display objects, the existence (sigh of presence) of users who are interested in the product, or who have been interested in the product, can be conveyed intuitively to the user.

In this embodiment, the display mode of each display object changes based on the relation between the user of the portable terminal 10 and the writer, and so merely by viewing display objects, the user of the portable terminal 10 can discriminate between persons in a prescribed relation with himself, and other persons. Specifically, an image G or comment C relating to a writer in a friendship relation with the user of the portable terminal 10 is displayed, so that the user of the portable terminal 10 can see the image or comment of a friend.

In this embodiment, the display mode of each display object changes according to whether the writer has purchased the specified product, and so the user of the portable terminal 10 can ascertain how many persons have actually purchased the product merely by viewing the display objects.

In this embodiment, the display mode of each display object changes according to whether the writer is viewing the product at the same time as the user of the portable terminal 10, and so the user of the portable terminal 10 can ascertain how many persons are viewing the same product at the same time from the display objects. By this means, it is expected that a sense of unity and camaraderie with other persons is imparted to the user of the portable terminal 10.

In this embodiment, the user of the portable terminal 10 can exchange messages with a person viewing the same product at the same time via a screen for chat F while viewing, displayed superimposed, a display object.

In this embodiment, the display mode of each display object changes based on user attributes of the writer, and so the user of the portable terminal 10 can ascertain tendencies of persons showing interest in the product merely by viewing display objects. For example, the user can learn the age group of persons who are interested in the product.

In the above, the invention has been explained in detail based on an embodiment thereof. However, the invention is not limited to the above embodiment. This invention can be variously modified without deviating from the gist thereof.

In the above embodiment, the display mode of a display object can change based on various data; but the display mode of display objects need not be changed between writers. In this relation, the purchase database 22, user database 24 and viewer database 34 may be omitted, or processing related to the screen for chat F may be omitted.

In the above embodiment, the product database 21, purchase database 22, writer database 23, and user database 24 were provided independently of the AR server 30, but these databases may exist within the AR server 30.

In the above embodiment, person-figure display objects were caused to be displayed on the screen of a portable terminal 10, but the design of the display objects themselves may be freely determined. For example, a prescribed character, head shots of each user, simple symbols, or similar may be displayed as display objects.

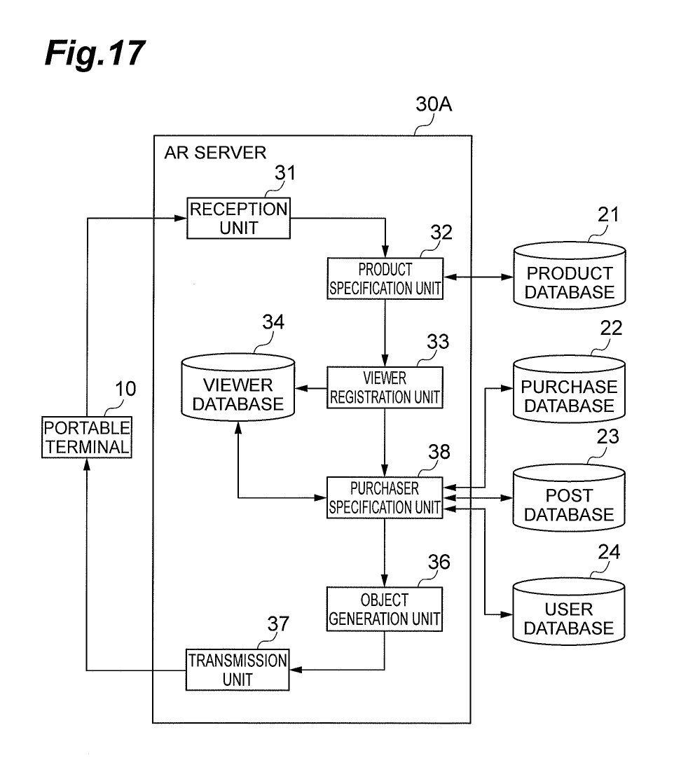

In the above embodiment, display objects indicating writers were generated; but display objects indicating purchasers may be generated. This modified example is explained using FIG. 17.

The AR server 30A shown in FIG. 17 comprises, instead of the writer specification unit 35 of the above embodiment, a purchaser specification unit (person specification means) 38. Other functional constituent elements of the AR server 30A are the same as in the above embodiment.

The purchaser specification unit 38 is means for referring to the purchase database 22 and specifying one or more users (purchasers) who have purchased a product specified by the product specification unit 32. The purchaser specification unit 38 performs the processing below for each product identifier input from the viewer registration unit 33.

First, the purchaser specification unit 38 reads out purchase data corresponding to a product identifier from the purchase database 22, to extract purchasers of the specified product. At this time, when the purchase data includes product IDs, as in FIG. 6(a), the purchaser specification unit 38 reads out one or more product IDs corresponding to a product identifier from the product database 21, and reads out purchase data corresponding to the one or more product IDs from the purchase database 22. When there exists a user who has purchased one product a plurality of times, purchase data for the user is extracted a plurality of times, but in this case, the purchaser specification unit 38 combines the redundant user IDs into one.

Next, the purchaser specification unit 38 acquires attributes of each purchaser, and acquires the relations between the requesting user and purchasers. This processing is similar to that performed by the writer specification unit 35.

Next, the purchaser specification unit 38 acquires the post status of each purchaser. Specifically, the purchaser specification unit 38 reads out, from the post database 23, post data corresponding to the product identifier and purchaser ID for each user ID of the acquired purchasers (hereafter called “purchaser IDs”). At this time, when the post data includes a product ID as in FIG. 7(a), the purchaser specification unit 38 reads out from the product database 21 one or more product IDs corresponding to the product identifier, and reads out from the post database 23 post data corresponding to the one or more product IDs.

Next, the purchaser specification unit 38 specifies those users among purchasers who are currently viewing the same product as the requesting user via a portable terminal 10. This processing is similar to that performed by the writer specification unit 35.

Next, the purchaser specification unit 38 generates object data to generate display objects based on the data acquired. In this modified example, object data is data which associates product identifiers, purchaser IDs, user attributes, friendship flags, posted flags, and viewing flags; a posted flag is set to “1” if the purchase has posted, and to “0” otherwise.

The purchaser specification unit 38 generates object data as described above for each input product identifier, and outputs the object data to the object generation unit 36. The object generation unit 36 decides the display modes (for example, size and color) for each display object, referring to the above posted flag as well.

In the modified example shown in FIG. 17 also, advantageous results similar to those of the above embodiment can be obtained. Specifically, product purchasers are specified, and display objects indicating the purchasers are generated and are displayed superimposed on the screen of the portable terminal 10, so that the number of persons who have purchased the product can be presented to the user of the portable terminal 10.

Further, the display mode of each display object changes according to whether the purchaser has commented on the product, so that merely by viewing display objects, the user of the portable terminal 10 can ascertain how many persons among purchasers have commented on the product.

The AR server 30 or 30A may also be configured so as to generate display objects indicating only the persons who have posted or purchased within a prescribed time interval in the past. In this case, the post data must further include the contributing date/time of comments. In the AR server 30, the writer specification unit 35 generates only object data for persons who have posted comments on the product within a prescribed time interval, based on the posting dates/times. In the AR server 30A, the purchaser specification unit 38 generates object data only for persons who have purchased the product within a prescribed time interval, based on the purchase dates/times.

The time interval serving as an extraction condition may be set in advance to an arbitrary value (for example, the most recently one-month period, or similar) in the AR server 30 or 30A, or a value which has been input or selected by the user using the portable terminal 10 may be used. In the case of a time interval set by the user, data indicating the time interval is sent, together with the user ID and photographic data, from the portable terminal 10 to the AR server 30 or 30A. In the writer specification unit 35 or the purchaser specification unit 38, only object data corresponding to the time interval is generated.

### REFERENCE SIGNS LIST

1 Information provision system
10 Portable terminal
11 AR processing portion
12 Image capture unit
13 Display unit
14 Transmission unit
15 Reception unit
21 Product database
21a Stocked product table
21b Catalog table
22 Purchase database (action database)
23 Post database (action database)
24 User database
24a User attribute table (user attribute database)
24b User relation table (user relation database)
30, 30A AR server (object display server)
31 Reception unit (reception means)
32 Product specification unit (product specification means)
33 Viewer registration unit
34 Viewer database
35 Writer specification unit (person specification means)
36 Object generation unit (object generation means, interface setting means)
37 Transmission unit (transmission means)
38 Purchaser specification unit (person specification means)
H A display object
P1 Object display program
P10 Main module
P11 Reception module
P12 Product specification module
P13 Browser registration module
P14 Browser storage module
P15 Writer specification module
P16 Object generation module
P17 Transmission module

1-14. (canceled)

15. An object display server, which implements superimposed-display of a display object on a screen of a terminal which displaying a processing target relating to a product,
the server comprising:
a reception unit for receiving an image of the processing target from the terminal requesting the display object;
a product specification unit for specifying a product corresponding to the processing target, based on a result of image identification processing on the image received by the reception unit and on product data stored in a product database;
a person specification unit for referring to an action database which stores action data indicating a prescribed action on a product taken by a person, and for specifying one or more persons who have taken a prescribed action on a product specified by the product specification unit, and generating object data including action information indicating an action of the one or more persons;
an object generation unit for generating one or more display objects from one or more object data generated by the person specification unit; and
a transmission unit for transmitting the one or more display objects to the terminal, in order to implement superimposed-display, on a screen of the terminal, of one or more display objects generated by the object generation unit, wherein
the object generation unit groups together the one or more object data, all of which indicate the same action information, and generates the one display object for each group, and generates each display object such that a display mode is different between at least one group and another group.

16. The object display server according to claim 15, characterized in that
the person specification unit extracts user relation data indicating a relation between the terminal user and the person from a user relation database which stores user relation data indicating a relation between users, and for each of the one or more persons generates the object data further including relation information indicating a relation between the users, and
the object generation unit groups together the one or more object data, all of which indicate at least the same action information and relation information, and generates the one display object for each group, and generates each display object such that a display mode is different between the group associated with the terminal user and the group not associated with the terminal user.

17. The object display server according to claim 16, characterized in that the object generation unit generates a display object of the group such that information relating to the group associated with the terminal user is displayed on a screen of the terminal.

18. The object display server according to claim 15, characterized in that
the action data includes post data indicating a comment related to a product on which a user has posted,
the person specification unit refers to the post data in the action database and specifies one or more persons who have commented on the product as writers, and generates the object data for the respective writers, and
the object generation unit generates one or more of the display objects by grouping together the object data indicating one or more of the writers.

19. The object display server according to claim 18, characterized in that the person specification unit specifies as writers only one or more persons who commented on the product within a prescribed time interval.

20. The object display server according to claim 18, characterized in that
the action data includes purchase data indicating product purchase by a user,
the person specification unit refers to the action database and extracts the purchase data indicating that the writer has purchased the product, and sets the action information in use of the purchase data, and
the object generation unit generates each display object such that a display mode is different between a group who has purchased the product and group who has not purchased the product.

21. The object display server according to claim 20, characterized in that the object generation unit sets a display position of each display object such that the display object of a group of writers who have purchased the product is displayed more closely to the processing target than the display object of a group of writers who have not purchased the product.

22. The object display server according to claim 18, characterized in that, when the display object displayed on a screen of the terminal is selected, the terminal displays the comment corresponding to the display object.

23. The object display server according to claim 15, characterized in that
the action data includes purchase data indicating product purchase by a user,
the person specification unit refers to the purchase data within the action database and specifies one or more persons who have purchased the product as purchasers and generates object data for each purchaser, and
the object generation unit generates one or more of the display objects by grouping together the object data of one or more of the purchasers.

24. The object display server according to claim 23, characterized in that the person specification unit specifies as purchasers only one or more persons who have purchased the product within a prescribed time interval.

25. The object display server according to claim 23, characterized in that
the action data includes post data indicating a comment related to a product posted by a user,
the person specification unit refers to the action database and extracts the post data indicating that the purchaser has commented on the product and sets the action information in use of the post data, and
the object generation unit generates each display object such that a display mode is different between the group who has commented on the product and the group who has not commented on the product.

26. The object display server according to claim 23, characterized in that, when the display object displayed on a screen of the terminal is selected, the terminal refers to the purchase data, and displays on the screen a history of products purchased in the past by a writer corresponding to the display object.

27. The object display server according to claim 15, further comprising a viewer database which stores viewer data indicating a user who is viewing a product on a terminal screen,
the object display server being characterized in that
the person specification unit extracts viewer data indicating the person who is viewing the product on a terminal screen and sets the action information in use of the viewer data, and
the object generation unit generates each display object such that a display mode is different between the group of the person viewing the product and the group of the person not viewing the product.

28. The object display server according to claim 27, further comprising an interface setting unit for, when there exists the person who is viewing the product, setting in the terminal a user interface enabling transmission and reception of a message between the terminal user and the person.

29. The object display server according to claim 15, characterized in that
the person specification unit extracts user attribute data relating to the person from a user attribute database which stores user attribute data indicating a user attribute and, for each the one or more persons, generates the object data further including attribute information indicating the user attribute, and
the object generation unit groups together one or more of the object data, all of which indicate at least the same action information and attribute information and generates the one display object for each group, and decides a display mode for the display object based on the attribute information.

30. The object display server according to claim 15, characterized in that the processing target is any among the entirety of or a portion of an actual article of a product, an image of a product, a character string that can specify a product, or an encoding of the character string.

31. The object display server according to claim 15, characterized in that
the object generation unit discontinues generation of the display object when the number of display objects exceeds a predetermined upper limit number, and
the transmission unit transmits the display objects in the number of the upper limit.

32. The object display server according to claim 15, characterized in that, in the terminal, the display object is displayed so as to approach the processing target from an edge of the screen.

33. An object display method executed by an object display server which implements superimposed-display of a display object on a screen of a terminal which displaying a processing target relating to a product,
the method comprising:
a reception step of receiving an image of the processing target from the terminal requesting the display object;
a product specification step of specifying a product corresponding to the processing target, based on a result of image identification processing of the image received in the reception step and product data stored in a product database;
a person specification step of referring to an action database which stores action data indicating a prescribed action on a product taken by a person, and specifying one or more persons who have taken a prescribed action on a product specified in the product specification step, and of generating object data including action information indicating an action of the one or more persons;
an object generation step of generating one or more display objects from one or more object data generated in the person specification step; and
a transmission step of transmitting one or more display objects to the terminal, in order to implement superimposed-display, on a screen of the terminal, of the one or more display objects generated in the object generation step, wherein
in the object generation step, the one or more object data, all of which indicate the same action information, are grouped together, and for each group, one display object is generated, and each display object is generated such that a mode of display is different between at least one group and another group.

34. A non-transitory computer-readable recording medium, which stores an object display program which causes a computer to function as an object display server which implements superimposed-display of a display object on a screen of a terminal which displaying a processing target relating to a product,
the object display program causing the computer to function as:
a reception unit for receiving an image of the processing target from the terminal requesting the display object;
a product specification unit for specifying a product corresponding to the processing target, based on a result of image identification processing of an image received by the reception unit and product data stored in a product database;
a person specification unit for referring to an action database which stores action data indicating a prescribed action on a product taken by a person, and for specifying one or more persons who have taken a prescribed action on a product specified by the product specification unit, and generating, for each of the one or more persons, object data including action information indicating an action of the person;
an object generation unit for generating one or more display objects from one or more object data generated by the person specification unit; and
a transmission unit for transmitting the one or more display objects to the terminal, in order to implements superimposed-display, on a screen of the terminal, of one or more display objects generated by the object generation unit, wherein
the object generation unit groups together the one or more object data, all of which indicate the same action information, and generates the one display object for each group, and generates each display object such that a display mode is different between at least one group and another group.
